(19) United States
(12) Patent Application Publication
(10) Pub. No.: US 2010/0236301 A1
(43) Pub. Date: Sep. 23, 2010

(54) LOCK

(76) Inventor: Stanley J. Demster, Lenexa, KS (US)

Correspondence Address: HUSCH BLACKWELL SANDERS LLP, 4801 Main Street, Suite 1000, KANSAS CITY, MO, 64112, US

(21) Appl. No.: 12/407,428

(22) Filed: Mar. 19, 2009

(51) Int. Cl. E05B 65/06

(52) U.S. Cl. 70/93

(57) ABSTRACT

The present invention is directed to a lock that provides a multipoint lock that includes reinforcement of the door and jamb on a relatively continuous basis. The lock is for installation in a residential or commercial door having a door frame or jamb and a door. The lock includes a fixed strip coupled to the door jamb, a sliding strip slidably coupled to an edge of the door configured to slidably engage the fixed strip, and a mechanism moveably engaged to the sliding strip for vertically moving the sliding strip to engage the fixed strip. Both the sliding strip and fixed strip have at least one tab extending outwardly therefrom and configured to engage each other. If desired, these tabs could be extended all along the sliding and fixed strips to provide a series of engagement points that serve to uniformly connect the door edge to the door jamb. Each tab on the door edge is formed so it can lock into the similar shaped tab on the door jamb to provide a secure point of connection. When the door is opened the tabs are aligned in a manner so they do not engage and then when the door is closed one set of tabs moves transversely to engage the opposite set of tabs.

### CROSS-REFERENCE TO RELATED APPLICATIONS

None.

### BACKGROUND OF THE INVENTION

The common deadbolt or multipoint deadbolt is the accepted standard for securing swing leaf and sliding leaf entry doors. These are the doors found in most residential and commercial structures. These mechanisms use a sliding bolt to engage a receiver in the jamb to create a barrier to the opening of the door. However the vast majority of the extensive prior art utilizes a bolt that travels outwardly from the door leaf at a right angle to the door edge. The bolt extends from the edge of the door to enter a receiver in the jamb to lock the door and then is retracted from the receiver to unlock the door. The strength of the connection or the ability of it to resist force is dependent on the shear strength of the bolt and the strength of the receiving device and the jamb itself. Historically, the methods to defeat this mechanism are prying the door and jamb apart at the point the bolt enters the jamb receiver or sudden impact at the bolt area which breaks the door or jamb due to the high concentration of forces in a limited area.

The limitations of the type of devices hereinabove has generated many improvements aimed at strengthening the connection of the door to the jamb by introducing either bolts that are longer, thicker or stronger. Bolts that are greater in number or located at the head and foot of the door have been used to make it more difficult to force the connection. The relative weakness of the jamb and door in resisting force has been addressed by reinforcing devices and stronger receivers for the bolt mechanism. These reinforcement devices often detract from the aesthetic appearance of the door and are not often used due to their appearance. However, in the end, all these mechanisms have failed to generate a lock mechanism that can resist most attacks from rams, hammers and pry bars. The limitations of common wood jambs, adjacent structures, light gauge steel studs and similar common building materials surrounding the door frame have not been adequately addressed. Therefore, it would be beneficial to provide a locking mechanism that is an improved securing means for the door in the closed position that provides a structurally more robust method of securing the door to the frame. It would also be beneficial to provide a locking mechanism that supplements the common door strike mechanisms, and replaces single point or multipoint lock systems.

With the contemporary focus on energy conservation, it is further desired that door locking mechanisms addressing the sealing of the door to prevent the entry of moisture, wind and the exfiltration of conditioned air from a building. Ideally the lock mechanism would enhance the sealing of the door as well as provide security functions. For example, the doors secured with a single latch point commonly are tight at the latch but loose at the door ends. Therefore, it would be beneficial to provide a locking mechanism that also functions to enhance drawing the door tight against weather seals, thereby increasing the seal of the door and preventing air leaks.

For the foregoing reasons as described, there is a need for a better method of securing the door leaf to the jamb than using either a single or multipoint sliding bolt mechanism. Furthermore, such a need exists for multiple leaf doors, sliding doors, and similar window mechanisms too. The bolt in shear concept is believed to be the limiting factor in producing a more secure connection between the door and jamb. This issue applies to virtually all doors and materials from the wooden residential doors to heavily reinforced steel doors used in commercial applications.

Advances in electronics and the fabrication of lock mechanisms have made it difficult to impossible to defeat door lock mechanisms by methods other than force. For example, a keypad can be placed at the non-secure side of the door and it is not subject to picking like a lock cylinder. Beyond keypads, there are card readers, biometric devices that read fingerprints, face recognition, palm recognition, retina scanners and radio controlled locks that have been introduced to operate the door locking device in a more secure manner. It would be beneficial to provide a locking mechanism that can be easily integrated with, interfaced to, or used with the described invention to provide a system that is now not only “pick proof” in the traditional sense but also virtually force proof within reasonable limits.

Prior art includes hundreds of variations of two themes. One is the use of a multipoint bolting system and the second is the door frame reinforcement devices. Hudson (U.S. Pat. No. 6,082,049) describes an improved door frame reinforcement at the deadbolt location. Previously Aliotta (U.S. Pat. No. 3,918,207) described a door frame reinforcement too as did Wendt (U.S. Pat. No. 4,281,480) but this approach alone is inadequate. Mortise lock improvements were described by Eller (U.S. Pat. No. 6,282,929) and MacNeil (U.S. Pat. No. 5,373,716) but these devices were simple latch pin devices with multiple connections between the door and frame that did little to prevent prying failure or frame material failures.

The reinforcement approach alone was also proposed by Arneson in his U.S. Patent application 20070096480. Another multipoint lock system was described by Fleming in his U.S. Patent application 20080078216. However, even these latest improvements fail to integrate improved multipoint locking with reinforcement and a method of clamping the door to the jamb in a manner that provides wide spread resistance to physical force. Therefore, it would be beneficial to provide a locking mechanism that provides a way to clamp the door to the jamb in order to spread resistance to physical force.

### SUMMARY OF THE INVENTION

The present invention is directed to a lock that provides a multipoint lock that includes reinforcement of the door and jamb on a relatively continuous basis. The lock is for installation in a residential or commercial door having a door frame or jamb and a door. The lock includes a fixed strip coupled to the door jamb, a sliding strip slidably coupled to an edge of the door configured to slidably engage the fixed strip, and a mechanism moveably engaged to the sliding strip for vertically moving the sliding strip to engage the fixed strip. Both the sliding strip and fixed strip have at least one tab extending outwardly therefrom and configured to engage each other. If desired, these tabs could be extended all along the sliding and fixed strips to provide a series of engagement points that serve to uniformly connect the door edge to the door jamb. Each tab on the door edge is formed so it can lock into the similar shaped tab on the door jamb to provide a secure point of connection. When the door is opened the tabs are aligned in a manner so they do not engage and then when the door is closed one set of tabs moves transversely to engage the opposite set of tabs. Unlike bolt mechanisms where the bolt moves or slides perpendicular to the hinge axis, this mechanism slides parallel to the door edge and hinge axis. For a typical vertical door, this device slides vertically while a conventional deadbolt mounted adjacent to the knob slides horizontally.

As one strip moves or slides parallel to the door edge, the tabs engage. Each end of the tab can be formed at or with a small angle to form a ramp or taper. As the tabs slide together, the door is forced more tightly against the door stop or seal. Thus, each tab can be configured, if desired, to uniformly force the door tight against the door seal.

The benefit of this invention in resisting force is developed by spreading out the forces of conventional attacking means. A hammer blow or kick that routinely would break a common deadbolt connection is spread out over a large area of the door edge and jamb edge. This invention distributes the force over such a large area that the strength of most jamb and door materials is now sufficient to resist the force of most common attacks. The thin strips engage multiple fasteners along the edge so there is no one point where forces can be concentrated. Using appropriate fasteners of the proper material and size allows the forces to be transmitted to the underlying structural members so the jamb material alone does not have to resist the attack forces.

The sliding strips and fixed strips can be formed from one piece of material or they can be formed from individual components mounted individually along the door edge and the door frame. Individual tabs can take the form of fastener devices like large flat head screws that allow individual depth adjustment for alignment purposes.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is a front perspective view of one embodiment of the lock of the present invention;

FIG. 2 is a front perspective view of the lock of FIG. 1 showing a portion of a sliding strip;

FIG. 3 is a front perspective view of the lock of FIG. 1 showing a portion of a fixed strip;

FIG. 4 is a front perspective view of the lock of FIG. 1 showing a mechanism for moving the sliding strip;

FIG. 5 is a top cross sectional view of the lock of FIG. 1 showing the sliding strip and the fixed strip engaged in a locked manner;

FIG. 6 is an illustration showing the installation of the lock of FIG. 1 in a standard door and door frame.

FIG. 7 is a font perspective view of a second embodiment of the lock of the present invention;

FIG. 8 is a front perspective view of an alternative embodiment of the sliding strip of the present invention;

FIG. 9 is a front perspective view of an alternative embodiment of the fixed strip of the present invention that corresponds to the sliding strip of FIG. 8;

FIG. 10 is a front perspective view of an alternative embodiment of the mechanism of the present invention showing a latch mechanism attached to a door surface mounted latching device;

FIG. 11 is a front perspective view of an alternative embodiment of the mechanism of the present invention showing a conventional deadbolt lock cylinder adapted to operate the sliding strip;

FIG. 12 is a front elevational view of the fixed strip showing how the interlocking tabs are formed and aligned along the strip along with the mounting apertures;

FIG. 13 is a front elevational view of the sliding strip showing how the interlocking tabs are formed and aligned along the strip;

FIG. 14 is a front elevational view of the fixed strip tabs that are formed by special fasteners that are designed to accommodate variances in the edge surface and the sliding strip that is similar to the previous sliding strips;

FIG. 15 is a top cross sectional view of the lock of FIG. 1 showing the sliding strip and the fixed strip engaged in a locked manner;

FIG. 16 is a top cross sectional view of an alternative configuration of the lock of FIG. 1 showing the sliding strip and the fixed strip engaged in a locked manner where the fixed strip is integrated as part of the door jamb; and

FIG. 17 is a top cross sectional view of another alternative configuration of the lock of FIG. 1 showing the sliding strip and the fixed strip engaged in a locked manner where the fixed strip is integrated as part of the doorjamb.

### DETAILED DESCRIPTION OF THE INVENTION

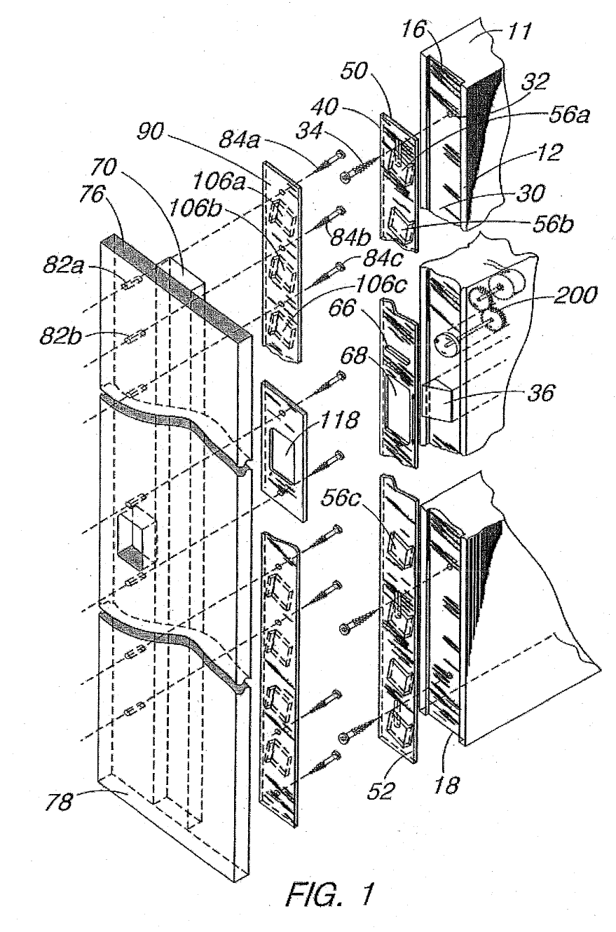

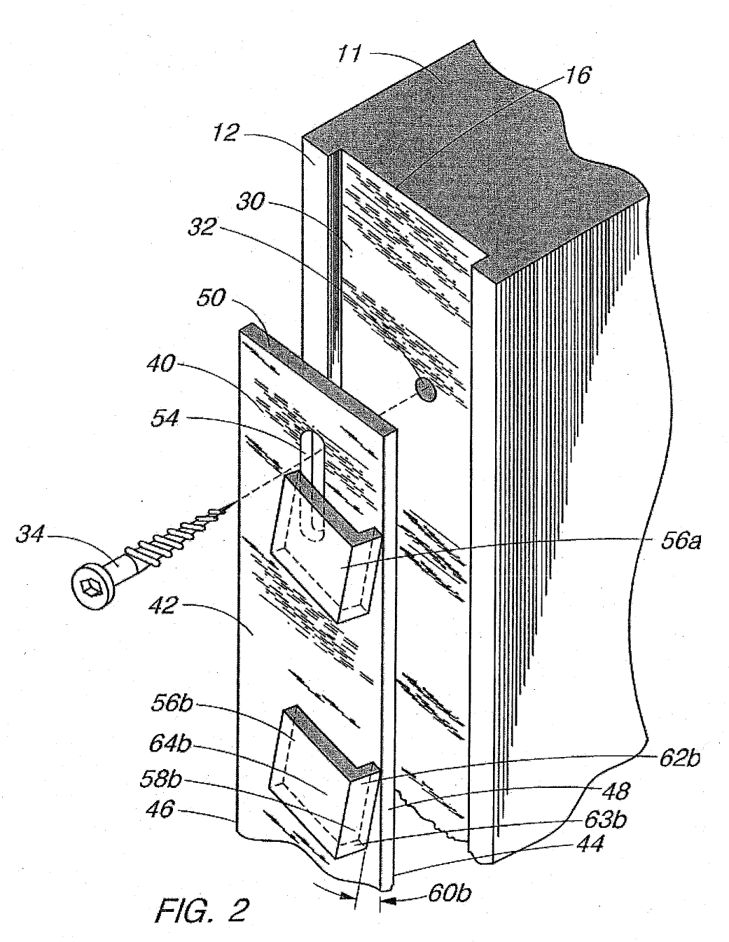

A lock 10 embodying various features of the present inventions is shown in the drawings. In a first embodiment, referring to FIG. 1, lock 10 can be installed on standard door when manufactured or lock 10 can be retrofitted to doors already installed. FIG. 1 illustrates an overall view of the first embodiment of the present invention. FIGS. 2-7 further illustrate individual aspects of the first embodiment. Referring to FIGS. 1-3, lock 10 provides a multipoint locking mechanism that includes reinforcement of a door 11 and a door jamb 70 on a relatively continuous basis. Lock 10 includes a sliding strip 40 slidably coupled to a door edge 12 of door 11, a fixed strip 90 installed along door jamb 70, and a mechanism 200 engaged with sliding strip 40 to transversely move sliding strip 40. A first channel 30 is formed in door edge 12 extending from a top edge 16 of door edge 12 to a bottom edge 18 of door edge 12 and is configured to receive sliding strip 40 and has an aperture 32 configured to receive fastener 34. First channel 30 may be formed by cutting or milling door edge 12. First channel 30 serves to partially conceal and protect sliding strip 40 and further provides a guide and bearing surface for sliding strip 40. First channel 30 may be made from a material or lined with a material that reduces friction such as, for example, plastic or solid lubricants. Sliding strip 40 is generally rectangular and includes a front face 42, an opposing back face 44 defining a first slot 54 therethrough, defining a second slot 66 therethrough, and defining an opening 68 therethrough, a left end 46, an opposing right end 48, a top end 50 and an opposing bottom end 52, a series of L-shaped tabs 56a, 56b, extended from front face 42. Sliding strip 40 may be made of relatively strong but thin material. Sliding strip 40 may be made from, but is not limited to, stainless steel sheet metal, thin brass sheet, cast or extruded aluminum, and plastics or composite materials that are engineered to provide adequate shear and tensile strength. As illustrated in FIG. 2, a first portion 58b of tab 56b is connected to front wall 42 and extends outwardly therefrom. Top edge 62b of first portion 58b is aligned with right side wall 48 and bottom edge 63b is angled outwardly from right side wall 48 at angle 60b. Angle 60a is approximately 10 degrees to the vertical. A second portion 64b is perpendicularly affixed to first portion 58b forming an L-shape. Sliding strip 40 is moveably affixed to channel 30 by fastener 34 engaging generally vertical first slot 54 and aperture 32. It will be appreciated by those skilled in the art that fastener 34 may be any number of various fasteners, such as, for example, a rivet, a bolt or other similar fastener that can connect sliding strip 40 to door edge 12 in a manner that allows for sliding strip 40 to slide vertically in channel 30. Fastener 34 may be installed in a manner so it can easily be removed and/or replaced or in a manner where it cannot be easily removed such as, for example, staking or welding. Fastener 34 should have a head configuration that allows it to hold sliding strip 40 securely in place but allows for relatively easy sliding through the clearance provided in first slot 54. Fastener 34 must have a flat head and/or fastener 34 must be recessed in sliding strip 40 to allow clearance for door 11 to close. First slot 54 should provide sufficient travel of sliding strip 40 so tabs 56a, 56b may engage and disengage corresponding tabs in fixed strip 90, discussed further herein. It will also be appreciated by one skilled in the art that there may be multiple points to connect sliding strip 40 to channel 30 by multiple fasteners engaging multiple slots in sliding strip 40 and connecting those slots with corresponding apertures in channel 30. Multiple points of connection are illustrated in FIG. 1. In this embodiment, fasteners 34a, 34b, etc. and apertures 32a , 32b, etc. when coupled with door edge 12 provide structural support so that the strength of first channel 30 or fasteners 34a, 34b, etc. alone are not required to resist forcing closed door 11 open when lock 10 is used to lock door 11 closed. Second slot 66 is generally horizontal and configured to receive mechanism 200. Opening 68 is configured to receive a dead latch 36 of door 11.

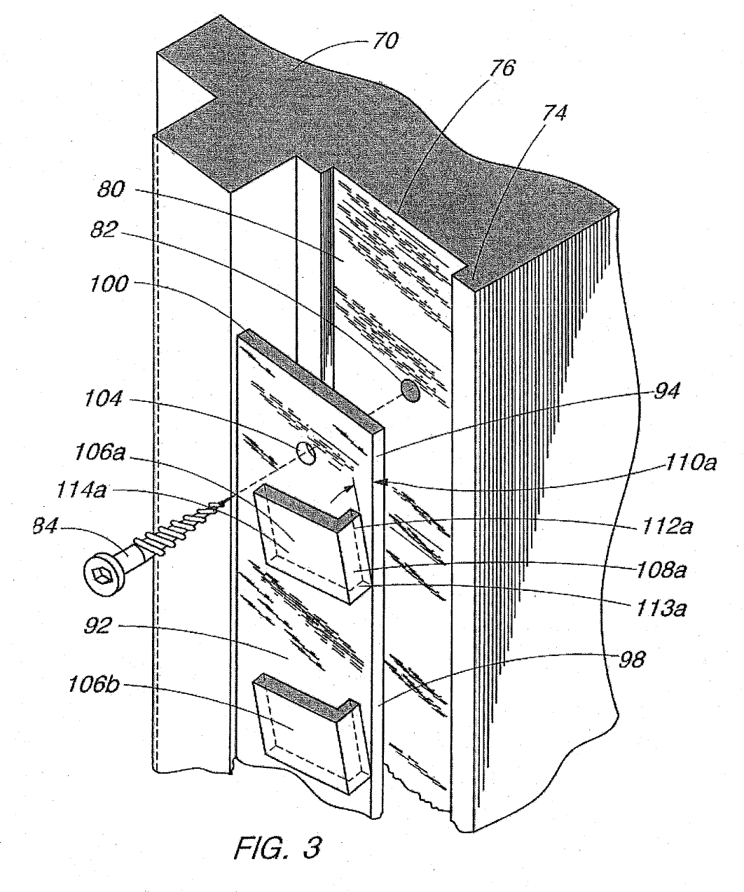

A second channel 80 is formed in a similar manner and for similar reasons as first channel 30 except second channel 80 is formed in a side face 74 of door jamb 70 extending from a top edge 76 of jamb 70 to a bottom edge 78 of jamb 70 and is configured to receive fixed strip 90. Channels 30 and 80, although helpful for reinforcing door edge 12 and side face 74, are not necessary. Fixed strip 90 is generally rectangular and includes a front wall 92, an opposing back face 94 defining an aperture 104 therethrough, a left wall 96, an opposing right wall 98, a top wall 100 and an opposing bottom wall 102, and a series of L-shaped tabs 106a, 106b extended from front face 92. Fixed strip 90 may be made of relatively strong but thin material. Fixed strip 90 may be made from, but is not limited to, stainless steel sheet metal, thin brass sheet, cast or extruded aluminum, and plastics or composite materials that are engineered to provide adequate shear and tensile strength. As illustrated in FIG. 3, a first portion 108a of L-shaped tabs 106a is affixed to front wall 92 and extends outwardly therefrom. Bottom edge 113a of first portion 108a is aligned with right side wall 98 and top edge 112a is angled outwardly from right side wall 98 at angle 110a. Angle 110a is approximately 10 degrees to the vertical. The specific angle is not critical and can be varied but angle 60a and 110a should be approximately the same. This slight rotation of tabs 56a, 56b forms a ramp when engaged with corresponding tabs 106a, 106b. A second portion 114a is perpendicularly affixed to first portion 108a forming an L-shape. Fixed Strip 90 is affixed to door jamb 70 by fastener 84 engaging apertures 104 and 82. It will be appreciated by those skilled in the art that fastener 84 may be any number of various fasteners, such as, for example, a rivet, a bolt or other similar fastener that can connect fixed strip 90 to door jamb 72. It will also be appreciated by one skilled in the art that there may be multiple points to connect fixed strip 90 to side face 74 by multiple fasteners engaging multiple apertures in fixed strip 90 and affixing those apertures with corresponding apertures in side face 74. Multiple points of connection are illustrated in FIG. 1. Fastener 84 may be installed in a manner so it can easily be removed and/or replaced or in a manner where it cannot be easily removed such as staking or welding. Fastener 84 should have a head configuration that allows it to hold fixed strip 90 securely in place. Fastener 84 must have a flat head and/or fastener 84 must be recessed in strip 90 to allow clearance for door 11 to close. First slot 54 should provide sufficient travel of strip 90 so tabs 106a, 106b may engage and disengage corresponding tabs in sliding strip 40, discussed further herein. In this embodiment, fasteners 84a, 84b, etc. and apertures 82a, 82b, etc. when coupled with door jamb 70 provide structural support so that the strength of second channel 80 or fasteners 84a, 84b, etc. alone are not required to resist forcing the closed door 11 open when lock 10 is used to lock door 11 closed. Opening 118 is configured to receive a dead latch 36 of door 11.

Tabs 56a, 56b, 106a, 106b serve to uniformly connect door edge 12 to jamb 70. Tabs 56a, 56b, 106a, 106b can have a multiplicity of shapes such as L-shaped, U-shaped, triangular, circular, cylindrical, elliptical, oblong, rectangular, wedge, tubular or conical. It will be appreciated by one in the art that any of these and other appropriate shapes may be used for tabs 56a, 56b, 106a, 106b. Throughout this disclosure tabs 56a, 56b, 106a, 106b are illustrated as L-shaped. It will be appreciated that a variety of configurations of tabs 56a, 56b, 106a, 106b are possible so long as each tab 56a, 56b on sliding strip is configured so it can lock into the similar shaped tabs 106a, 106b on jamb 70 to provide a secure point of connection. When door 11 is opened tabs 56a, 56b and corresponding 106a, 106b are aligned in a manner so they do not engage and when door II is closed sliding strip 40 and therefore tabs 56a, 56b move transversely to engage the opposite set of tabs 106a, 106b on fixed strip 90. Unlike bolt mechanisms where the bolt moves or slides perpendicular to the hinge axis, this mechanism slides parallel to the door edge and hinge axis. For a typical vertical door, the present invention slides vertically while a conventional deadbolt mounted adjacent to the knob slides horizontally. As sliding strip 40 moves or slides parallel to the door edge, tabs 56a, 56b engage with tabs 106a, 106b, respectively. Alternatively, each end of tabs 56a, 56b, 106a, 106b can be formed at or with a small angle to form a ramp or taper (not shown). As tabs slide together, the door is forced more tightly against the door stop or seal. Thus, each tab can be configured, if desired, to uniformly force the door tight against the door seal.

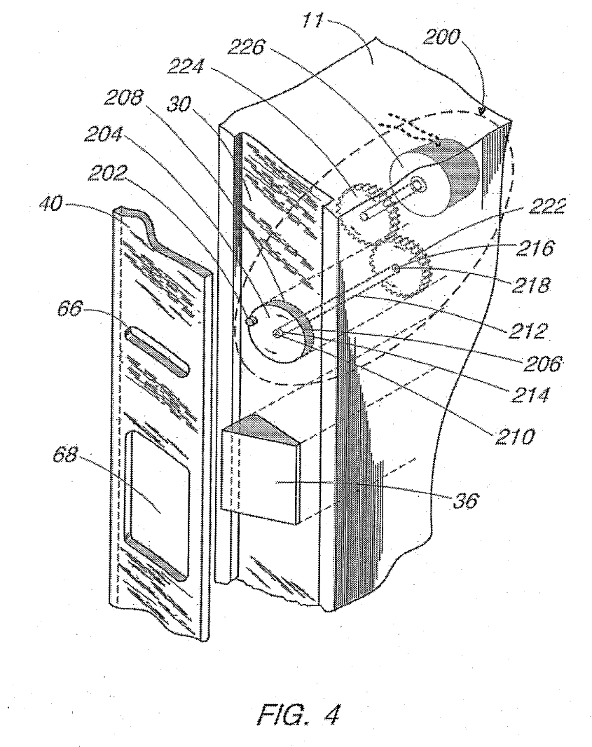

Referring to FIG. 4, mechanism 200 is illustrated. Mechanism 200 is installed in the typical location that a deadbolt bolt hole is found in door 11. In place of the customary deadbolt bolt mechanism is a rotating cylinder 204 having a front face 206 and a back face 208. An extent 202 is affixed to the proximate edge of front face 206. Extent 202 is approximately cylindrical, is made of hardened metal, and is configured to engage second slot 66 of sliding strip 40. Extent 202 may be, but is not limited to, a pin, a lug, a bolt, a flange, a peg, or a knob. Extent 202 rotates as cylinder 204 is rotated and as cylinder 204 rotates extent 202 travels horizontally in second slot 66. Second slot 66 has an approximate length that is equal to or greater than the diameter of rotation of extent 202. One half turn of 180 degrees of cylinder 204 causes sliding strip 40 to travel the full vertical distance required to properly engage fixed strip 90. Because cylinder 204 is at the top of its travel when sliding strip 40 is fully engaged, extent 202 essentially locks sliding strip 40 in place because at top dead center a vertical force on sliding strip 40 or extent 202 will not cause rotation of cylinder 204. The force vector would pass directly through the center of cylinder 204. Alternatively, extent 202 may have a head, lip or retainer groove to attach extent 202 to sliding strip 40. To protect the interface of extent 202 to sliding strip 40, channel 30 may provide a recess that conceals the connecting point from tampering from the outside. Additional, protection (not shown) may be provided by an auxiliary enclosure plate/cover or similar means on door edge 12. A generally cylindrical shaft 212 having a first end 214 attached to proximate center 210 of back face 208 of cylinder 204 and a second end 216 attached to proximate center 218 of face 220 of gear 222 and is used to rotate cylinder 204. Gear 222 is connected to a gear train 224 which is connected to and rotated by an electric motor 226. Gear train 224 provides torque multiplication that allows a relatively small motor to overcome the friction of sliding strip 40. Motor 226 also provides a self-locking feature (not shown) that prevents sliding strip 40 from moving unless motor 226 turns. Gear train 224 could be replaced by a belt and pulleys, a multiple gear set or a direct drive motor if that motor has adequate torque.

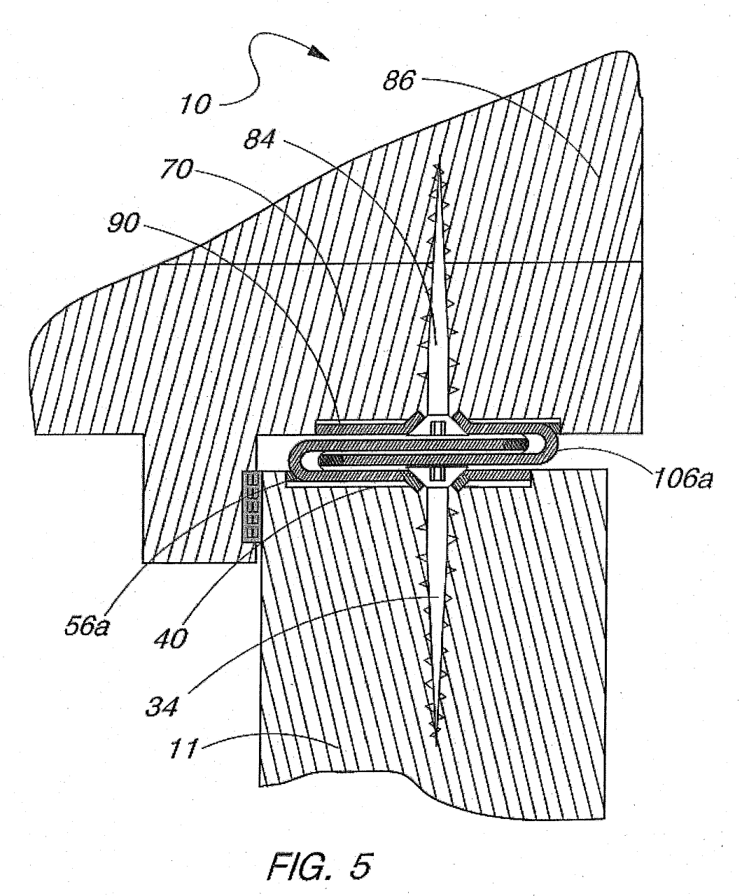

Referring to FIG. 5, a top cross section of door 11 closed against door jamb 70 is illustrated showing the first embodiment of the present invention with tab 56a engaged with 106a. Fastener 84 for fixed strip 90 is shown penetrating door jamb 70 and passing through to wall structure 86 that is coupled to door jamb 70. Sliding strip 40 is slidably coupled to door 11 by fastener 34.

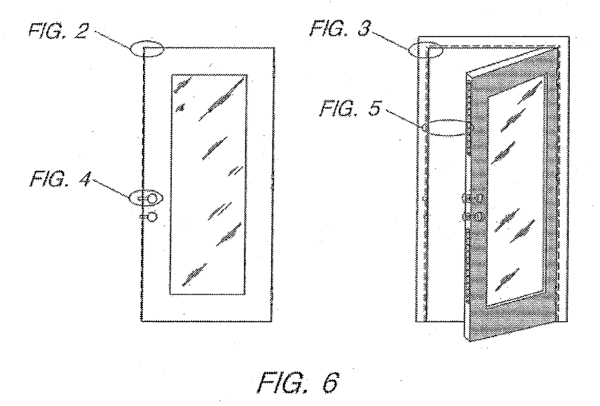

Referring to FIG. 6, a typical door set is shown and each figure disclosed above is shown where each portion of lock 10 would be installed.

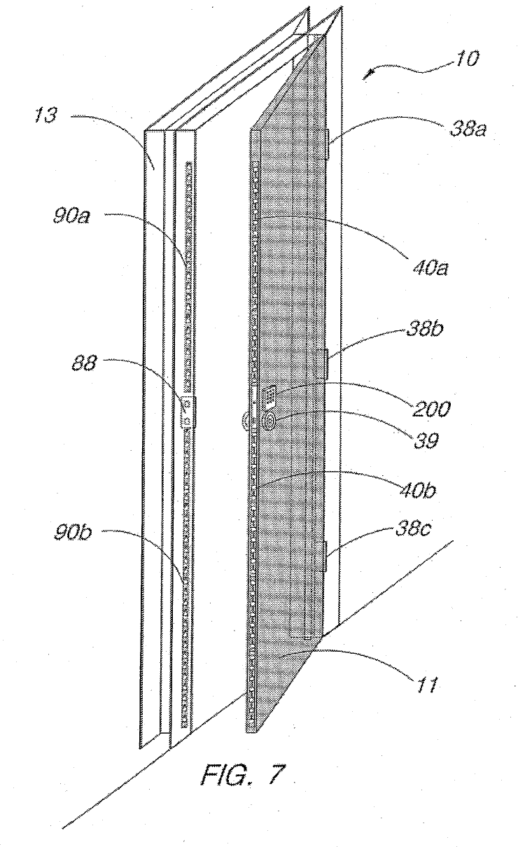

In a second embodiment, referring to FIG. 7, lock 10 is shown installed in a standard door 11 with door 11 partially open to allow viewing of the elements of the present invention. Door frame 13 is conventional in construction and material and is installed in the normal manner with the minor exception that door 11 is carefully aligned with door frame 13 so they are parallel and produce the proper gap between door 11 and door frame 13 to allow the invention to be installed in the gap. Door strike 88 is in the conventional location and has the conventional construction. Door 11 is of convention material, size and shape. Hinges 38a, 38b, 38c are of typical construction and location as any typical door, though for purposes of adding security to the present invention, hinges 38a, 38b, 38c could be optionally stronger or increased in number to provide greater physical strength. In this embodiment, fixed strip 90 is shown as two separate pieces, illustrated in FIG. 7 as 90a and 90b, and are installed above and below door strike 88. The construction and installation of fixed strips 90a and 90b are similar in manner to the construction and installation of fixed strip 90 described with respect to the first embodiment. In this embodiment, sliding strip 40 is shown as two separate pieces, illustrated in FIG. 7 as 40a and 40b, and are installed in a manner such as to correspond with fixed strip 90a and 90b when closed but aligned such that tabs located on opposing strips miss each other when lock 10 is unlocked. Fixed strip 90a is installed as one continuous piece but alternatively it could be a series of shorter strips arranged to provide the desired length of engagement. Fixed strips 90a, 90b are installed using fasteners of appropriate configuration for the type of door frame 13 used. For typical wood frames and residential applications these fasteners would pass through strip 90 and frame 13 and engage the structural studs to securely hold strip 90 in place without depending on the strength of frame 13 alone. Door 11 can be optionally provided with a conventional door latch 39 that secures door 11 without operation of the present invention much like a deadbolt device. Sliding strips 40a, 40b are installed along door edge 12 of door 11. Latch 39 has no effect on the operation of lock 10 and lock 10 has no effect on the operation of latch 39. Mechanism 200 moves the sliding strips 40a, 40b vertically to lock and unlock lock 10. Mechanism 200 may be, but is not limited to, an electronic device that uses a keypad and/or a radio signal to operate sliding strips 40a, 40b much like a conventional deadbolt. FIG. 7 illustrates mechanism 200 as an electronic device and includes an electric motor (not shown) that causes sliding strips 40a, 40b to move from the locked to unlocked positions. The internal mechanism (not shown) of mechanism 200 provides a rotary motion that is converted into a vertical translation of the sliding strips 40a, 40b.

Alternatively, door latch 39 and mechanism 200 can be combined into what is often referred to as a “combo” lock where a handle (not shown) of latch 39 can operate both the latch function and the deadbolt function. The configuration of lock 10 would then be very similar to the configuration that operates a conventional deadbolt. This is a feature of the invention that allows it to use these traditional and conventional mechanisms plus use the same holes and mounting configurations found into today's doors and frames.

In an alternative configuration, not illustrated in a particular drawing herein, the sliding strip or multiple sliding strips are coupled to other edges of the door rather than the door edge and door jamb edge. In another alternative configuration, not illustrated in a particular drawing herein, the sliding strip or multiple sliding strips are coupled to the door jamb while the fixed strip or strips are coupled to the door.

For any of the embodiments disclosed herein, both the sliding and fixed strips can be configured to be of any desired length providing engagement along the whole edge of the door or for only a portion of the door.

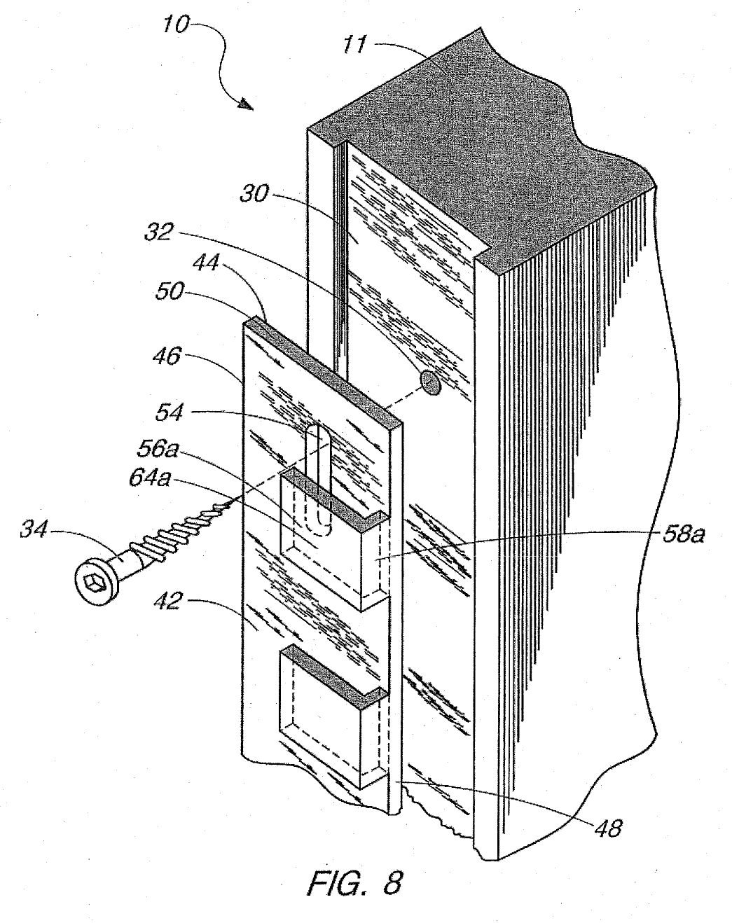

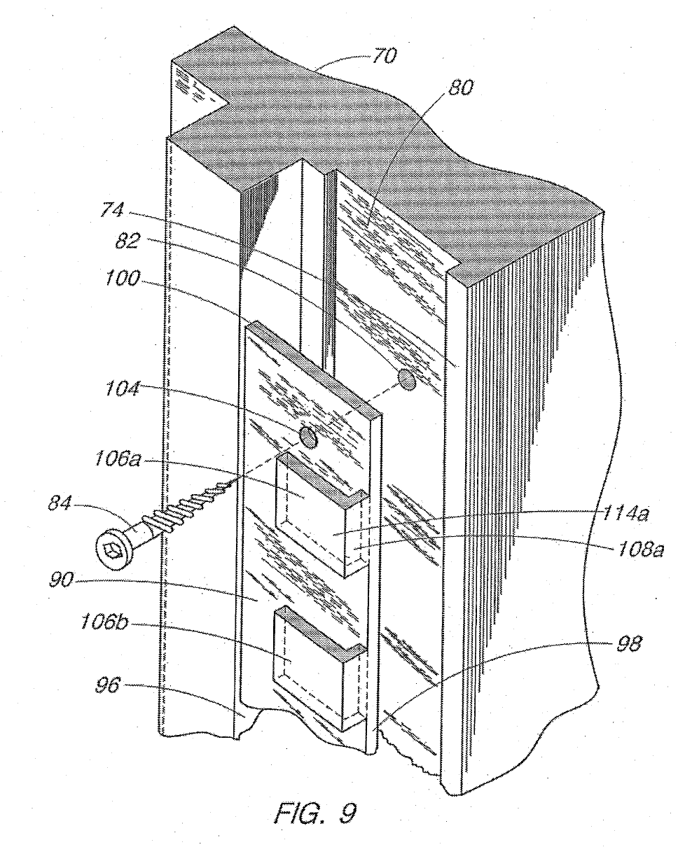

In a third embodiment, illustrated in FIGS. 8 and 9, lock 10 is constructed in a manner as described with respect to FIGS. 1-5 except for the alignment of tabs 56a, 56b, 106a, 106b. Referring to FIG. 8, first portion 58a of tab 56a is perpendicularly coupled to and extends outwardly from front face 42 of sliding strip 40 such that first portion 58a is flush with right side wall 48 of sliding strip 40. Second portion 64a extends perpendicularly from first portion 58a. Referring to FIG. 9, first portion 108a of tab 106a is perpendicularly coupled to and extends outwardly from front face 92 of sliding strip 90 such that first portion 108a is flush with right side wall 98 of sliding strip 90. Second portion 114a extends perpendicularly from first portion 108a.

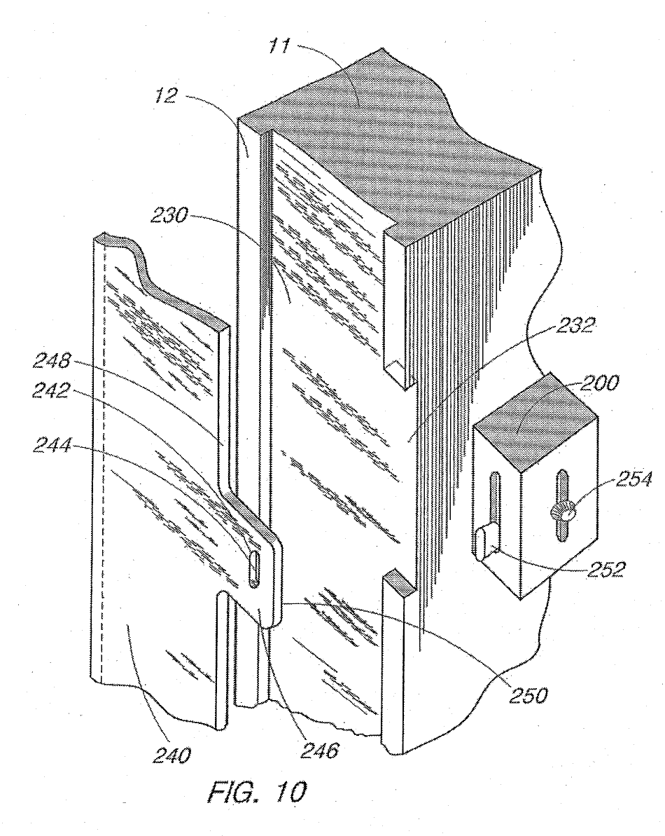

In a fourth embodiment, illustrated in FIG. 10, lock 10 is constructed in a manner as described with respect to FIGS. 1-5 except for an alternative configuration for mechanism 200. A first channel 230 is constructed in a similar manner as first channel 30 described hereinabove except a notch 232 is provided for receiving an arm 242 of a sliding strip 240. Sliding strip 240 is constructed in a similar manner as sliding strip 40 described hereinabove except that arm 242 extends outwardly from right wall 248 and has a front face 246 and a back face 250 defining a slot 244 therebetween. Slot 244 is configured to receive member 252 of mechanism 200. Mechanism 200 is coupled to door 11 and is generally rectangular in shape having a sliding operator 254 coupled to member 252. Sliding operator 254 may be manual or automated. Any mechanism that provides vertical translation can be used to move sliding strip 240 from the engaged to disengaged position. If desired, mechanism 200 may arranged to provide operation on both inside and outside of the door (not shown).

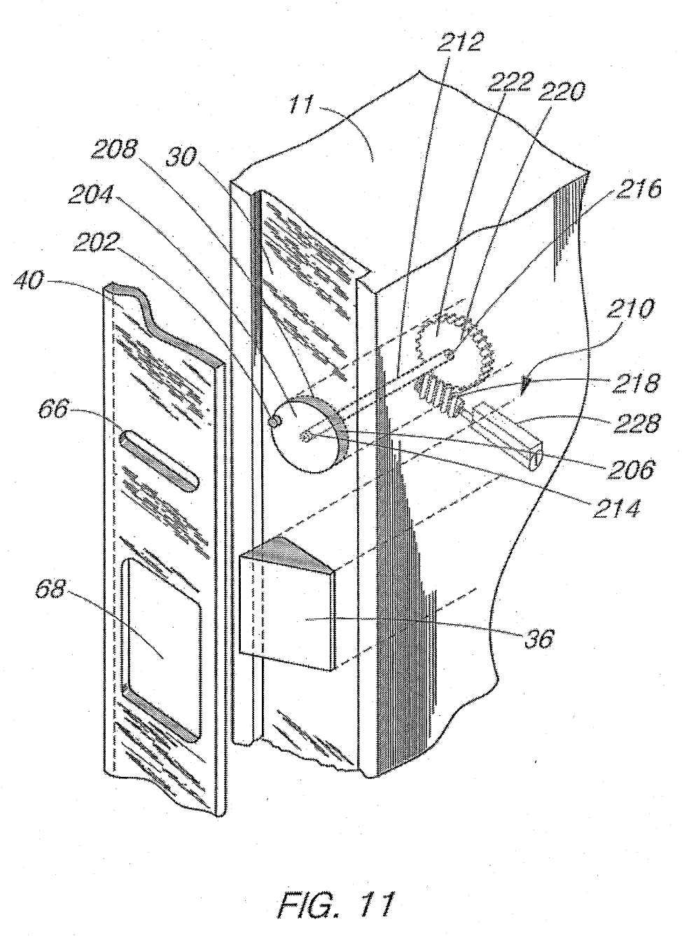

In a fifth embodiment, illustrated in FIG. 11, lock 10 is constructed in a manner as described with respect to FIGS. 1-5 except for an alternative configuration for mechanism 200 that allows a conventional key cylinder 210 to operate sliding strip 40. Cylinder 206 is rotated by shaft 212 and gear 220. Gear 220 is rotated by a worm gear 218 which is connected to a lock cylinder 228. Worm gear 218 and gear 220 provide both a right angle change in rotation and a torque multiplication that allows the turning of the key to overcome the friction of sliding strip 40. Worm gear 218 also provides a self-locking feature that prevents lock 10 from moving unless the lock cylinder 228 turns. Lock cylinder 228 would be placed in the same hold and position as customarily used for deadbolt locks. Lock cylinder 228 would be fitted with customary trim to create an identical appearance of an existing deadbolt lock.

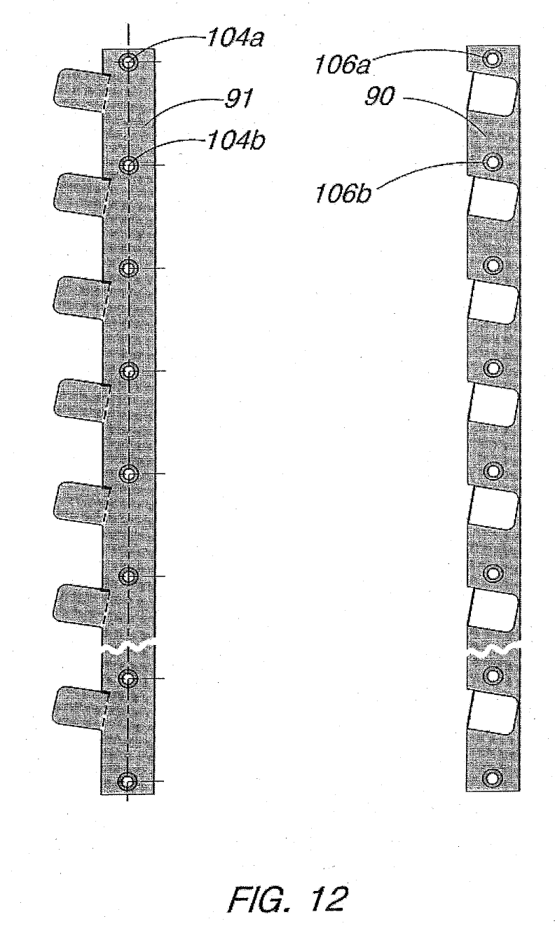

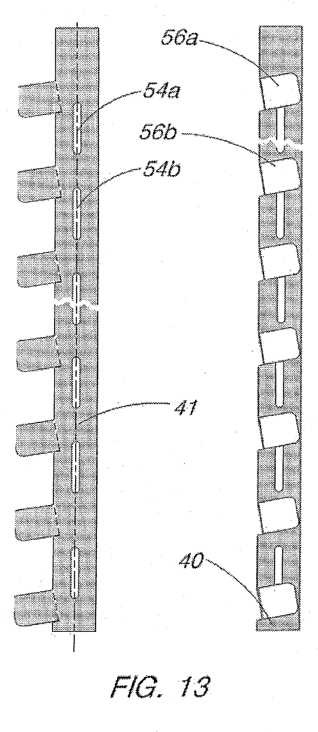

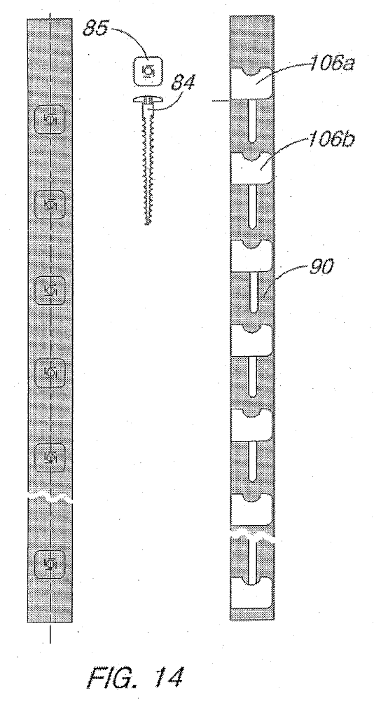

FIGS. 12-14 illustrate different ways that tabs 106 and 56 are constructed on fixed strip 90 and sliding strip 40. This construction may be used for any of the above disclosed embodiments. FIG. 12 illustrates fixed strip 90 as fabricated from a piece of thin metal. Strip 91 illustrates the metal before tabs 106a, 106b are formed by bending the metal upwards 180 degrees. Tabs 106a, 106b are bent to form a 10 degree rotation to the vertical. Apertures 104a, 104b are formed by being punched or drilled in the metal with a recess around it so a fastener head can be reasonably flush with the metal surface when it is installed. FIG. 13 illustrates sliding strip 40 as fabricated from a piece of thin metal. Strip 41 illustrates the metal before tabs 56a, 56b are formed by bending the metal upwards 180 degrees. Tabs 56a, 56b are bent to form a 10 degrees rotation to the vertical. Slots 54a, 54b are punched or milled in the metal with a smooth edge so a fastener shaft can provide a low friction bearing point and support as sliding strip 90 slides to engage and disengage fixed strip 90. FIG. 14 illustrates another way fixed strip 90 is fabricated. Tabs 106a, 106b are formed by fastener 84. Fastener 84 has a large flat head 85 that allows it to perform the function of a fixed interlocking tab. A guide template, decal or strip is used to precisely locate each fastener 84. The purpose of using fastener 84 as the tab itself is to allow fastener 84 to provide an adjustable placement of the tab surface. By screwing fastener 84 in further or by backing it out the distance of the head 85 can be adjusted. This adjustment feature can be used to align the corresponding tabs on the sliding strip when the door edge and jamb surface are not aligned.

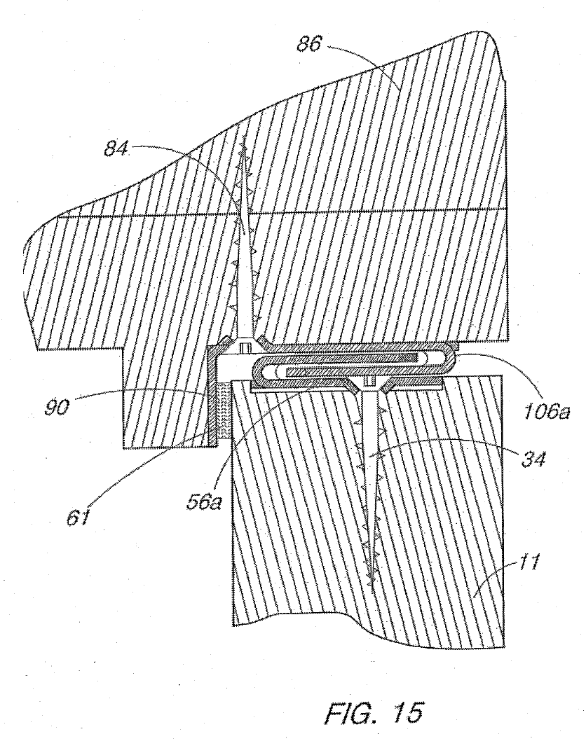

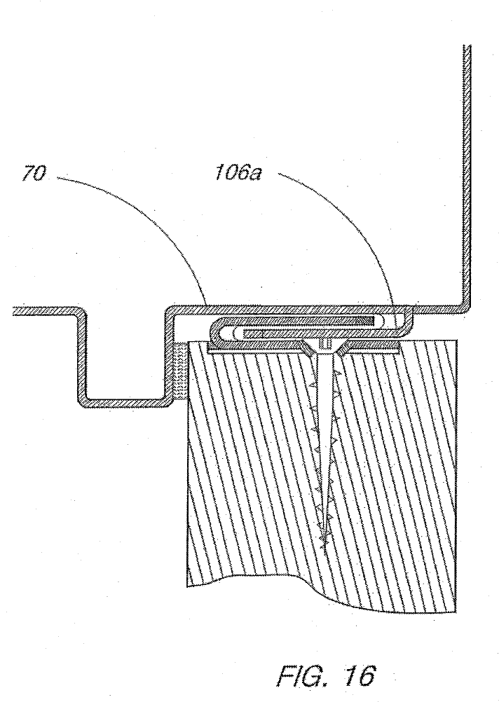

FIGS. 15-17 are top cross sections various configurations of door 11 closed against door jamb 70 with tab 56a engaged with 106a. Referring to FIG. 15, sliding strip 40 and fixed strip 90 are fully engaged and door 11 is pulled tight against door jamb 70. Fastener 84 is shown penetrating door jamb 70 and passing through to wall structure 86. The door stop is abutted by seal 61 and fastener 84 is arranged in a manner that causes it to no longer be in the path of sliding strip 40. Referring to FIG. 16, this alternative configuration does not require for fixed strip 90 to be coupled using fasteners rather fixed strip 90 is integrated into a metal door frame with tab 106a being formed by the same metal material as door jamb 70.

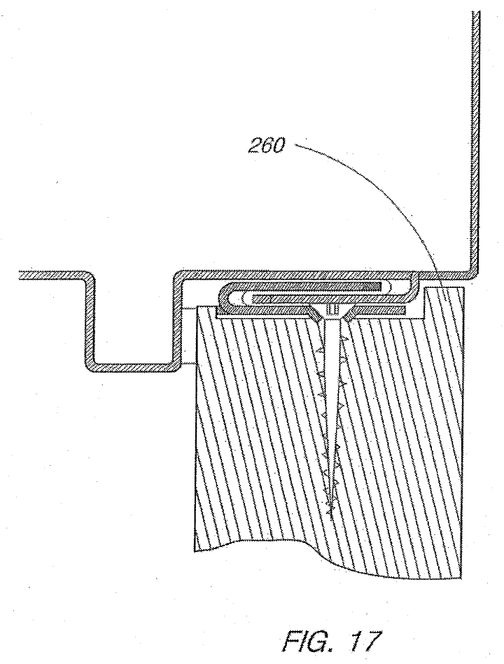

In addition to the above there are special configurations that may be used for commercial door construction. The door and door hardware industry is subject to extensive regulation based on fire codes and security requirements established by the NFPA and other code authorities and testing organizations. These established requirements affect the design, installation and operation of the described deadbolt replacement device. In particular, there is a requirement that fire doors not be field modified without losing their fire rating. This mandate implies the fire rated doors must be configured in the factory to use the new technology as described. Referring to FIG. 17, a section of a rated door with an extension of door edge 260 to address code issues. This shape of the door edge provides a limited clearance between the door edge and frame of less than one eighth inch as required for fire rating, plus it shields the door securing devices from accidental damage and prying associated with an attempted break-in. Depending on the material used to construct the door, the door edge extension can be formed into the door using a wide variety of methods. For a steel door composed of steel sheet, this extension could be one of more folded and formed layers of steel. The extension could also be a steel member welded to the door leaf. However, in all cases this extension would be required to be included as part of the door itself when the door is tested and rated by the manufacturer rather than field attached to a field modified door. Exit doors often require the installation of panic hardware to release the locking mechanisms. To provide the panic hardware function with the new securing device the panic hardware will need to incorporate an operator mechanism to release the securing device like present deadbolts are released. This hardware can take many forms and due to the fact the new device uses an operator much like existing deadbolts it is a simple matter to adapt existing panic hardware to be used with this new device. One such configuration would be a panic hardware bar that when pushed provides a 180 degree rotation of the new device operator to cause it to slide to the open and unlocked position. A wide variety of cams, levers, gears and similar items can be arranged to translate pressure on the panic device into the release of the new device. It is virtually impossible to address all the potential configurations of operators that will work or can be modified to work in this manner.

The sliding strip is normally positioned so the tabs on it are aligned to miss the tabs on the fixed strip when the door is being closed. After closing, the sliding strip is then moved to lock the door by aligning the tabs so they engage. However, in an alternate embodiment, the sliding strip and fixed strip can be made from a material that has flexible or spring properties. The door can then be closed with the tabs on the fixed and sliding strips aligned. The aligned tabs on the strips compress closed slightly and then spring open to engage when the door is closed. This snap action will cause the door to be automatically latched and locked whenever the door is closed. To open the door the sliding strip must slide in the normal manner to unalign the tabs and disengage the lock or latch function. If desired this latch and lock function can be controlled with a traditional door knob or lever operator, with or without, a key-in-knob lock cylinder. This latch function can be further enhanced by aligning the tabs so they are partially engaged when the door is closed to loosely latch the door and then they can be fully engaged by the operator to lock the door and draw in tight using the ramps incorporated into the tab design. It is further desirable that the tabs could be arranged to include several spring material latching tabs with several much more rigid locking tabs. Thus, the tabs on the strips need not be made from a uniform material or configuration to provide the latch and lock functions.

One benefit of this invention in resisting force is developed by spreading out the forces of a conventional assault on the door. A hammer blow or kick that routinely would break a common deadbolt connection is spread out over a large area of the door edge and jamb edge. This invention distributes the force over such a large area that the strength of most jamb and door materials is now sufficient to resist the force of most common attacks. The thin strips engage multiple fasteners along the edge so there is no one point where forces can be concentrated. Using appropriate fasteners of the proper material and size allows the forces to be transmitted to the underlying structural members so the jamb material alone does not have to resist the attack forces.

The following generally applies to all embodiments described herein. To operate this invention, conventional mechanical lock cylinders and rotating lock mechanisms can be used. Existing doors and pre-hung doors that are manufactured with an 1½ inch or 2⅛ inch round hole for a deadbolt cylinder, and a 2⅜ inch or 2¾ inch backset are easily adapted to a mechanism that uses the key cylinder to turn a worm and gear that is connected to a cam that causes the strip attached to the door to translate vertically a nominal ¾ inch to engage and disengage the tabs. This arrangement of components can be easily adjusted to accommodate other setbacks of the lock and other distances or pitches of the locking strip that would allow alternate travel distances from the locked to unlock positions.

Using an electronic based mechanism like a key reader, card reader or other electronic device, an electric motor or solenoid can be used to drive a gear, lever and/or cam to provide vertical travel of the strip to engage or disengage the tabs. The most elementary mechanism can be a handle attached to the strip to allow the strip to be moved directly by hand. The strip can be held in place, either engaged or disengaged by a variety of mechanical stops, catches or lever devices. With this invention, the physical lock mechanism and method of deploying the movable strip can be widely varied with little effect on the physical performance of the invention. As long as the lock mechanism used has adequate force to overcome the friction produced by the stationary and movable strips rubbing together the invention will function satisfactorily. Additional force is required to use the ramp feature to clamp the door against the door seal.

There are a number of fabrications, installation and operational issues that pertain to this invention as proposed. In terms of fabrication, the interlocking tabs can be made from a wide range of materials though a material like stainless steel may prove to be the most durable. The door jamb material itself can be used to form the tabs if desired when a metal jamb material is used. The material thickness of the strips and/or tabs can be varied to address the desired strength required for a specific application. Even a thin brass material like conventional weather stripping material can provide very substantial strength. For heavier duty, forgings or castings can be used for large scale and high strength applications.

The fixed tabs can be formed from one piece of material or they can be formed from individual components mounted individually along the door edge. Individual tabs can take the form of fastener devices like large flat head screws that allow individual depth adjustment for alignment purposes.

The sliding nature of the one strip and the rotation of the operator in many configurations as shown in the embodiment drawings can be utilized with appropriate sensor devices to indicate the condition of the device in a locked and secure position or in an unlocked and non-secure position. Appropriate devices like indicator lights or alarm inputs can be easily and readily connected to the invention to integrate it into conventional security and alarm systems. The ability to operate the device using a conventional small electric motor or solenoid operator allows traditional and conventional access control devices to be easily integrated with the device.

The device can be installed in a multiplicity of configurations. The strips can be almost continuous along the door edges or they can be shorter sections. One edge or all four edges can be fitted with the strips. The sliding strip can be placed on the door with the fixed strip on the jamb or they can be reversed with the sliding strip on the jamb and the fixed strip on the door. This flexibility allows the operator devices to be mounted on the door or on the wall as desired by a specific application. For multi-leaf doors, the fixed and sliding strips can be applied to each door for a door to door lock.

Most applications will require an alignment of the strips to limit friction and assure correct engagement and disengagement. The strips or row of tabs on each surface must be parallel. The U-shaped gap and pitch of the tabs can be varied to address a requirement for more or less alignment precision. Large gaps and larger pitches will have less strength relative to smaller gaps and smaller pitches but will require less critical alignment. To reduce friction and provide adjustment of the tab engagement the moving strip and fixed strip can be fitted with shims or a carrier strip material. For example a plastic U-shaped channel could be formed into the door to allow the strip to slide within it. Shimming would allow the strips to be aligned if the door edge to jamb alignment was uneven or non-parallel.

The previous discussion described single leaf swinging door applications but this description can be expanded to include double leaf swinging doors, sliding doors and articulated doors that have a similar jamb and door interface. Even circular doors or hatches can be fitted with the sliding and fixed strips to provide similar protection and function to that of the swinging door. Specific applications and materials may demand slight modifications to the shape of the tabs that are appropriate for the application in terms of positioning and strength.

The previous discussion was addressing building doors but cabinet doors, boat or ship hatches, aircraft doors and automotive doors would also represent suitable applications for the door fastening or locking method described herein. The term door can also be expanded to include windows and other openings that need securing with a lock similar to a door.

While the previous discussion described advantages of the device as it pertains to attacks by prying or physical ramming, the configuration of the device provides closure physical properties that are equally beneficial in resisting the forces of wind, explosion, and similar pressure caused by fluids like air or water under pressure. The application of the device with compressive seals as shown in illustrations provides a uniform pressure against the seals that allows for an improved sealing of the door against leakage when compared to traditional devices.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A lock for installation on a window or a door, said window or door having a frame defining an opening and a closure member for closing said opening, said lock comprising:
a fixed strip coupled to one of said frame or said closure member;
a sliding strip coupled to the other of said frame or said closure member, wherein said sliding strip is configured to slidably engage said fixed strip; and
a mechanism moveably engaged with said sliding strip for vertically sliding said sliding strip to reversibly engage said fixed strip.

2. The lock of claim 1 wherein said door is a residential door, a commercial door, a sliding door, a double leaf swing door, an articulated door, a hatch, a circular door, an aircraft door or an automotive door.

3. The lock of claim 1 wherein said sliding strip is generally rectangular and includes a front face having at least one tab affixed to and extending outwardly therefrom and further includes at least one generally vertical slot therethrough and at least one generally horizontal slot therethrough, and wherein said fixed strip is generally rectangular and includes a front face having at least one tab affixed to and extending therefrom and further includes at least one aperture therethrough, and further wherein said fixed strip tab is configured to engage said sliding strip tab.

4. The lock of claim 3 wherein sliding strip is slidably coupled to said closure member by a fastener engaged with said at least one vertical slot and wherein said fixed strip is coupled to said frame by a fastener engaged with said at least one aperture.

5. The lock of claim 3 wherein said fixed strip tabs and said sliding strip tabs have a shape wherein said shape is selected from the group consisting of L-shaped, U-shaped, triangular, circular, cylindrical, elliptical, oblong, rectangular, wedge, tubular, and conical.

6. The lock of claim 3 wherein said sliding strip tabs are angled outwardly from an edge of said sliding strip defining a sliding strip angle and fixed strip tabs are angled outwardly from an edge of said fixed strip defining a fixed strip angle wherein said sliding strip angle and said fixed strip angle are approximately the same wherein said sliding strip tabs engage fixed strip tabs.

7. The lock of claim 3 wherein said mechanism is selected from the group consisting of an electric motor, an electronic device, a pulley system, a latch, a deadbolt mechanism, a worm and gear mechanism, and a gear mechanism.

8. The lock of claim 7 wherein said mechanism is installed within said closure member and includes a projection engaging said horizontal slot of said sliding strip.

9. The lock of claim 3 wherein a first channel is configured in said closure member to receive said sliding strip and a second channel is configured in said frame to receive said fixed strip.

10. The lock of claim 1 wherein said sliding strip is selected from the group consisting of stainless steal sheet metal, thin brass metal, cast aluminum, extruded aluminum, plastic, and composite material.

11. The lock of claim 1 wherein said fixed strip is selected from the group consisting of stainless steal sheet metal, thin brass metal, cast aluminum, extruded aluminum, plastic, and composite material.

12. A lock for installation on a window or a door, said window or door having a frame defining an opening and a closure member for closing said opening, said lock comprising:
a fixed strip coupled to one of said frame or said closure member, wherein said fixed strip is generally rectangular and includes a front face having at least one tab affixed to and extending outwardly therefrom and further includes at least one aperture therethrough; and
a sliding strip coupled to the other of said frame or said closure member, wherein said sliding strip is generally rectangular and includes a front face having at least one tab affixed to and extending outwardly therefrom and further includes at least one generally vertical slot therethrough and at least one generally horizontal slot therethrough; and
a mechanism moveably engaged with said sliding strip for vertically sliding said sliding strip to reversibly engage said fixed strip.

13. The lock of claim 12 wherein said sliding strip is slidably coupled to said closure member by at least one fastener through said at least one generally vertical slot and further wherein said fixed strip is coupled to said frame by at least one fastener through said at least one aperture.

14. The lock of claim 12 wherein said sliding strip is selected from the group consisting of stainless steal sheet metal, thin brass metal, cast aluminum, extruded aluminum, plastic, and composite material.

15. The lock of claim 12 wherein said sliding strip is selected from the group consisting of stainless steal sheet metal, thin brass metal, cast aluminum, extruded aluminum, plastic, or composite material.

16. The lock of claim 12 wherein said mechanism is installed within said closure member and includes a projection engaging said horizontal slot of said sliding strip.

17. The lock of claim 12 wherein said mechanism is selected from the group consisting of an electric motor, an electronic device, a pulley system, a latch, a deadbolt mechanism, a worm and gear mechanism, and a gear mechanism.

18. A lock of claim 12 wherein said fixed strip and said sliding strip are made from a flexible material wherein said closing member closes said opening said sliding strip and said fixed strip automatically engage.

19. A lock to lock a door by means of sliding at least one tab attached to a door edge in relation to at least one corresponding fixed tab attached to a doorjamb in an axial direction parallel to a door hinge axis.

20. The lock of claim 19 where said sliding tabs and said fixed tabs have a multiplicity of fasteners affixing said tabs to said door edge and said door jamb and arranged to distribute imposed loads on said door edge and said door jamb to effectively reinforce said door.
